(19) United States
(12) Patent Application Publication
(10) Pub. No.: US 2006/0002374 A1
(43) Pub. Date: Jan. 5, 2006

(54) System and method for event notification in a J2EE environment

(76) Inventors: William R. Trost, Mequon, WI (US); Scott Ryan Watry, New Berlin, WI (US); Peter Robert Neuwald, Milwaukee, WI (US)

Correspondence Address: TOLER & LARSON & ABEL L.L.P., 5000 PLAZA ON THE LAKE STE 265, AUSTIN, TX, 78746, US

(21) Appl. No.: 10/884,382

(22) Filed: Jul. 2, 2004

(51) Int. Cl. H04L 12/66

(52) U.S. Cl. 370/352

(57) ABSTRACT

An event notification system includes a J2EE compliant Java resource adapter. The Java resource adapter monitors to receive events received by a web application server from a manager server. As events are received at the web application server, the Java resource adapter determines whether to deliver each event. Moreover, if an event is deliverable, the Java resource adapter notifies the targeted application component and transmits the event to an application server. The application server, in turn, transmits the event to the targeted application component and a code fragment corresponding to the event may be executed at the application component.

### FIELD OF THE INVENTION

The present disclosure relates to an event notification system and method for managing networks and network data.

### BACKGROUND

Modern telecommunication companies currently provide numerous services and features that can be purchased in addition to traditional services such as local calling and long-distance calling. For example, custom calling features can include: caller identification, call waiting, three-way calling, call forwarding, remote call forwarding, automatic call back, repeat dialing, speed dialing, call rejection, and call hunting. Moreover, with the explosion of the Internet, telephone service providers now also provide high-speed Internet services, e.g., digital subscriber line (DSL) service. These services can be purchased individually or in bundles. As a result of the growth of services provided by telecommunication companies, it has become increasingly difficult to manage the services.

Modern graphical user interface (GUI) environments used by telecommunication service provider are typically event-driven. Events occur in such an environment when a user performs particular tasks such as moving a computer mouse, clicking or toggling buttons presented via a computer monitor, and pressing a key on a computer keyboard, etc.

It appears that in the near future, many telecommunication companies may utilize the Java 2 Platform, Enterprise Edition (J2EE), introduced in 1998, to fulfill their networking needs. J2EE defines a multi-tier architecture for enterprise information systems (EIS). By defining the way in which multi-tier applications should be developed, J2EE reduces the costs, in both time and money, of developing large-scale enterprise systems. However, the J2EE platform does not describe a system to manage telecommunication services.

Accordingly, there is a need for a system and method of managing networks that can work in conjunction with J2EE.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of an event notification system; and

FIG. 2 is a flow chart to illustrate the logic of a J2EE event notifier.

### DETAILED DESCRIPTION OF THE DRAWINGS

An event notification system includes a manager server that is connected to a web application server. In turn, a server queue is connected to the web application server. Plural application servers are connected to the server queue and plural application components can be connected to each application server. A Java 2 Platform, Enterprise Edition (J2EE) event notifier module resides within the web application server. The event notifier module monitors to receive events from the manager server. Moreover, when the J2EE event notifier module receives an event from the manager server, it determines whether to deliver the event. Thereafter, the J2EE event notifier module determines to which application server to route the event. The J2EE event notifier module transmits the event to a server queue and notifies an application server of the event. In turn, the application server retrieves the event from the server queue and notifies an application component of the event. Finally, the application server transmits the event to the application component and the application component executes a code fragment that corresponds to the event.

In another aspect of the present embodiment, a web application server is provided. The web application server includes a java resource adapter that can be used to route events received by the web application to application components in communication with the web application server.

In yet another aspect of the present embodiment, a method for routing events to application components in a Java 2, Enterprise Edition environment is provided. The method includes listening for the events and determining which applications to route the events as the events are received.

An example of a product for managing services is a Service Management System (SMS). The SMS is a database server that can centralize management of critical service and subscriber data. The SMS can provide plural operations support functions and includes a feature for migrating subscriber data from an older service version to a new service version. Also, the SMS can include a data collection function for accumulating and reporting service-level and subscriber-level measurements gathered by a network element. The SMS can further provide an audit feature, which can be used as a troubleshooting tool for detecting discrepancies between the SMS and the network element versions of recently changed data.

Another function that the SMS can provide is bulk provisioning. In other words, the SMS provide the capability to provision bulk data whenever a customer's service provisioning requires such input rather than a single entry at a time from a graphical user interface (GUI). Moreover, the SMS can provide the ability to perform network element queries and simulated test queries. Finally, the SMS can provide re-homing, which is useful for relocating a subscriber's records from a previous network element to a new network element if the previous network has been outgrown. The re-homing feature can be used to restore network elements after recovery from a failure. An example of an SMS is the Enhanced Service Manager (eSM) that is offered commercially by Lucent Technologies.

To provide the above-described functionality, an SMS can utilize object-oriented programming. In object-oriented programming, a computer operates by responding to events rather than stepping through a series of actions. In other words, code fragments can be written such that they are associated with special events. When the events occur, the code fragments are executed.

In order to manage telecommunication services and provide desired functionality, an SMS typically handles a flurry of events from consumers that may be monitoring and/or changing their service information, and service providers, who may be monitoring, tracking, and/or manipulating their customer information. Typically, an SMS can use a Common Object Request Broker Architecture (CORBA). CORBA is a vendor-independent architecture and infrastructure that computer applications can use to communicate with other computer applications. CORBA defines a standard for a layer of middleware called the Object Request Broker (ORB), which is used, in the standard CORBA protocol, Internet inter-ORB protocol (IIOP). IIOP extends transmission control protocol/Internet protocol (TCP/IP) by adding CORBA defined messages for objects to connect to each other over the network.

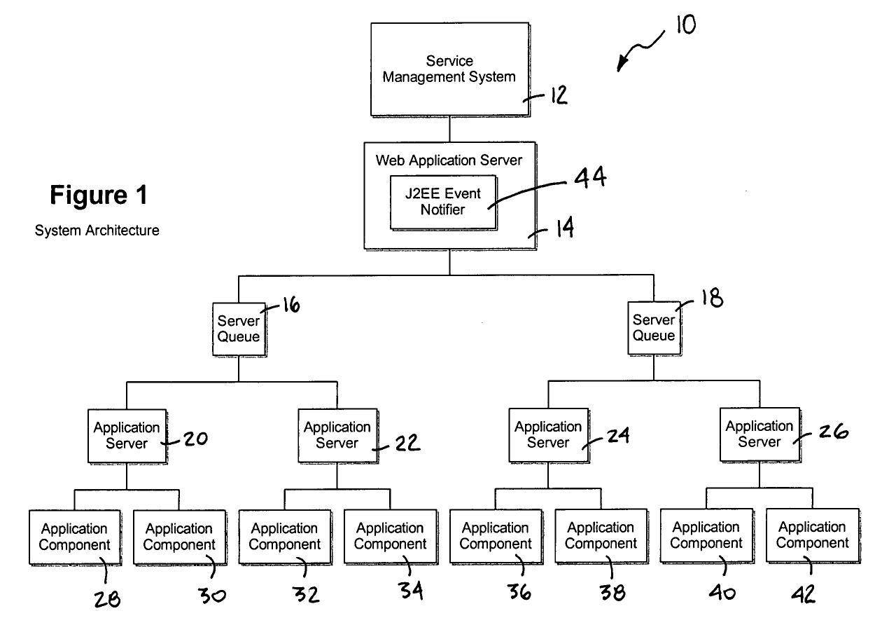

Referring initially to FIG. 1, an exemplary, non-limiting embodiment of event notification system is shown and is generally designated 10. As shown, the system includes an SMS server 12 that is connected to a web application server 14. It is to be understood that the web application server 14 can be any Java 2 Platform, Enterprise Edition (J2EE) compliant web application server such as an IBM WebSphere server or a BEA WebLogic server. FIG. 1 shows that the web application server 14 can be connected to a first server queue 16 and a second server queue 18. It can be appreciated that the inclusion of two server queues 16, 18 is merely exemplary and the system 10 can include more than two server queues 16, 18.

As shown in FIG. 1, the first server queue 14 can be connected to a first application server 20 and a second application server 22, but it can be appreciated that the first server queue 14 can be connected to more than two application servers 20, 22. Also, the second server queue 18 is connected to a third application server 24 and a fourth application server 26. It can be appreciated that the second server queue 18 can also be connected to more than the two application servers 24, 26 shown in FIG. 1.

FIG. 1 further shows that the first application server 20 communicates with a first application component 28 and a second application component 30. Also, in an exemplary, non-limiting embodiment, the second application server 22 communicates with a third application component 32 and a fourth application component 34. As shown, the third application server 24 can communicate with a fifth application component 36 and a sixth application component 38. And, the fourth application sever 26 communicates with a seventh application component 40 and an eighth application component 42. After reading the specification, skilled artisans will appreciate that each of the application servers 20, 22, 24, 26 can be connected to more than two application components and that the inclusion of only two application components per application server 20, 22, 24, 26 is merely for the clarity of the discussion of the present embodiment. In an exemplary, non-limiting embodiment, the application components can be Enterprise Java Beans (EJB), J2EE clients, processors, or any combination thereof.

As shown in FIG. 1, the web application server 14 includes a J2EE event notifier module 44. It is to be understood that the J2EE event notifier module 44 may be implemented as a Java resource adapter that can be plugged into any J2EE compliant web application server. The J2EE event notifier module 44 runs in the background within the web application server 14 and waits for events to be received come from the SMS server 12. As described in detail below, the J2EE event notifier module 44 can route received events to the proper application component where it can be executed. After reading this specification, skilled artisans can appreciate that connections between the above-described components, e.g., between the SMS server 12 and the web application server 14, can be established via a network connection, e.g., local area network (LAN) connections, wide area network (WAN) connections, wireless network connections, TI connections, etc.

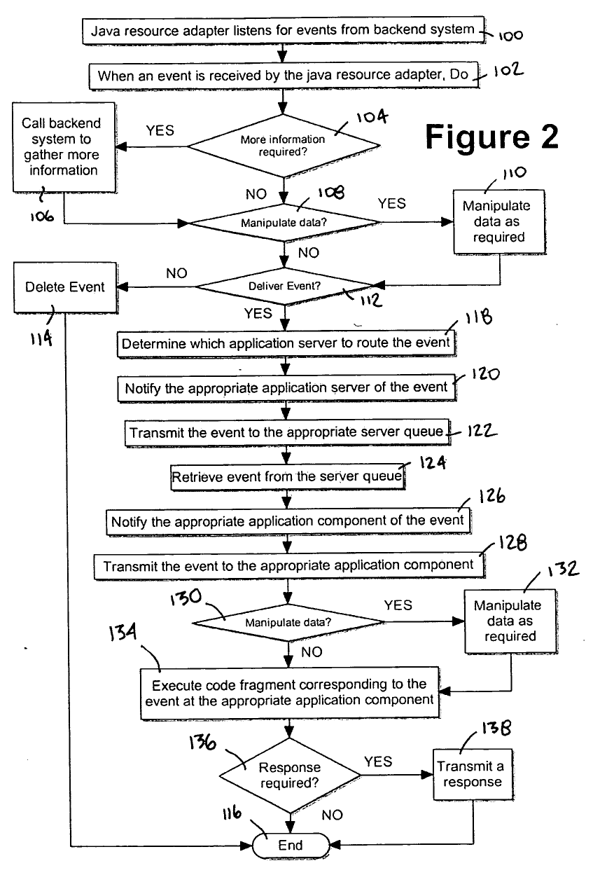

Referring now to FIG. 2, operating logic of an illustrative method is shown and commences at block 100, wherein a Java resource adapter, e.g., the J2EE event notifier module 44 shown in FIG. 1, listens for events from a backend system, e.g., the SMS server 12 shown in FIG. 1. It can be appreciated that the events can be CORBA calls, XML objects, or any other database queries in the appropriate programming languages, e.g., C++. At block 102, when an event is received by the java resource adapter, the succeeding steps are performed. Proceeding to decision step 104, the java resource adapter determines whether it requires more information. If so, the logic continues to block 106 wherein the java resource adapter calls the backend system to gather more information. Thereafter, the logic proceeds to decision step 108 and continues as described below.

Returning to decision step 104, if the java resource adapter does not require more information, the logic moves to decision step 108. At decision step 108, it is determined whether the event data needs to be manipulated. If so, the event data is manipulated as required by the java resource adapter. The logic then proceeds to decision step 112. From decision diamond 108, the logic also proceeds to decision step 112—if the event data does not need to be manipulated. At decision step 112, the java resource adapter determines whether the event is to be delivered. This determination can be based on user defined settings. As such, the java resource adapter can act as a filter to remove events that a user does not want delivered. If it is determined that the event is not to be delivered at decision step 112, the logic advances to block 114 and the event is deleted. The logic then ends at state 116. On the other hand, if the event is to be delivered, the logic moves to block 118.

At block 118, the java resource adapter determines to which application server the event is to be routed. The java resource adapter then notifies the appropriate application server of the event at block 120. Next, at block 122, the event is transmitted to the appropriate server queue. Moving to block 124, the appropriate application server retrieves the event from the server queue. Continuing to block 126, the application server notifies the appropriate application component of the event. Thereafter, at block 128, the event is transmitted to the appropriate application component. Next, at decision step 130 the application component determines whether the event data needs to be manipulated by the application component. If so, the logic proceeds to block 132 where the event data is manipulated by the application component as required. The logic then progresses to block 134. The logic also progresses to block 134 from decision step 130—if the data does not need to be manipulated. At block 134, a code fragment corresponding to the event is executed at the appropriate application component.

Proceeding to decision step 136, the application component determines whether a response is required based on the code fragment executed at the application component. If so, the logic advances to block 138 and a response is returned. The logic then ends at state 116. At decision step 136, if a response is not required, the logic moves to state 116 and ends.

It is to be understood that in addition to its notifier duties, the java resource adapter can also monitor connections between the SMS server 12 (FIG. 1) and the web application server 14 (FIG. 1). The java resource adapter can verify that the connections are active. Moreover, the java resource adapter can establish connections as needed.

Accordingly, the present embodiment provides ajava resource adapter than can be plugged into any J2EE compliant web application server to listen for events received by the web application server from a backend system, e.g., the SMS server 12 shown in FIG. 1. The java resource adapter can notify application components of deliverable events and then, route the deliverable events to the appropriate application components.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An event notification system, comprising:
a telecommunications network manager server;
at least one web application server connected to the manager server;
at least one server queue connected to the web application server;
at least one application server connected to the server queue;
at least one application component connected to the application server; and
a J2EE event notifier module residing within the web application server, the event notifier module to monitor for receipt of at least one event from the telecommunications network manager server.

2. The system of claim 1, wherein the J2EE event notifier module determines to which application server to route the event, and wherein the telecommunications network manager server is a service management system server.

3. The system of claim 2, wherein the J2EE event notifier module transmits the event to a server queue and notifies an application server of the event.

4. The system of claim 3, wherein the application server retrieves the event from the server queue and notifies an application component of the event.

5. The system of claim 4, wherein the application server transmits the event to the application component and the application component executes a code fragment corresponding to the event.

6. A web application server, the web application server comprising:
a java resource adapter, the java resource adapter to route events received by a web application to application components in communication with the web application server.

7. The server of claim 6, wherein the java resource adapter is J2EE compliant.

8. The server of claim 7, wherein the java resource adapter comprises logic for:
monitoring to receive at least one event; and
when the at least one event is received, determining an application component to which the event is to be routed.

9. The server of claim 8, wherein the java resource adapter further comprises logic to determine if the event is to be delivered.

10. The server of claim 9, wherein the java resource adapter further comprises logic to notify an application server of the event.

11. The server of claim 10, wherein the java resource adapter further comprises logic for transmitting the event to a server queue.

12. The server of claim 11, wherein the java resource adapter further comprises logic to notify an application component of the event.

13. The server of claim 12, wherein the java resource adapter further comprises logic for transmitting the event to the application component.

14. A method for routing at least one event to at least one application component in a Java 2, Enterprise Edition environment, comprising:
monitoring to receive the at least one event; and
when the at least one event is received, determining an application component to which the event is to be routed.

15. The method of claim 14, further comprising:
determining if the at least one event is to be delivered.

16. The method of claim 15, further comprising:
notifying an application server of the event.

17. The method of claim 16, further comprising:
transmitting the event to a server queue.

18. The method of claim 17, further comprising:
notifying an application component of the event.

19. The method of claim 18, further comprising:
transmitting the event to the application component.

20. The method of claim 19, further comprising executing a code fragment corresponding to the event at the application component.
